(19) United States
(12) Patent Application Publication
(10) Pub. No.: US 2011/0044885 A1
(43) Pub. Date: Feb. 24, 2011

(54) Process for Obtaining Sulfur from Feed Gas Containing H2S

(75) Inventor: Mathias Fischer, Kronberg (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: Lungi GmbH, Frankfurt am Main (DE)

(21) Appl. No.: 12/867,191

(22) PCT Filed: Oct. 29, 2008
(86) PCT No.: PCT/EP2008/009136

§ 371 Date: Sep. 9, 2010

(30) Foreign Application Priority Data
Feb. 12, 2008 (DE) 10 2008 008 769.6

(51) Int. Cl. C01B 17/02

(52) U.S. Cl. 423/567.1

(57) ABSTRACT

The invention relates to a method for production sulfur from an input gas comprising H₂S, wherein a part of the H₂S is burned in the presence of O₂ and/or air to form SO₂, and H₂O, and the SO₂ is reduced to sulfur and H₂O using at least one catalyst and further H₂S. In order to be able to control the temperatures in the combustion chamber, feedwater is sprayed into the process gas present in the combustion chamber.

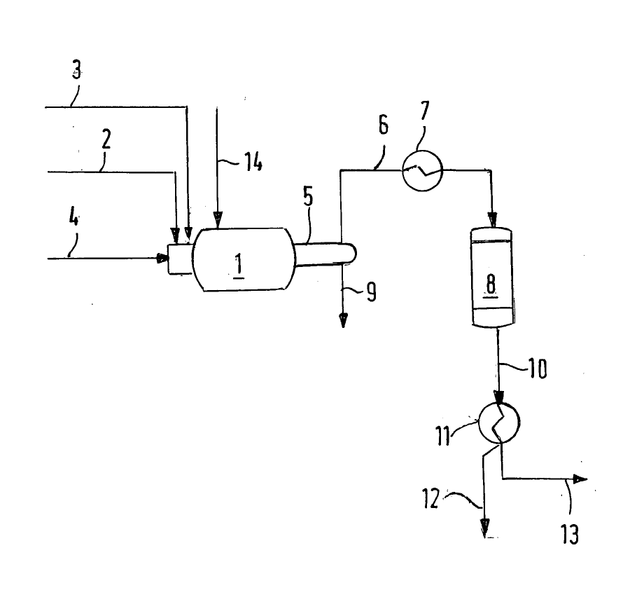

This invention relates to a process for obtaining sulfur from feed gas containing H₂S, wherein part of the H₂S is partially burnt in a combustion chamber in the presence of O₂ and/or O₂-containing gas at a pressure of 1.4 to 2.0 bar[a] to form SO₂ and H₂O, and in at least one catalyst stage the SO₂ is reduced to elementary sulfur and H₂O by using further H₂S.

This so-called Claus process is the most frequently used process worldwide for industrially obtaining sulfur from feed gases containing H₂S, as they are obtained for example in the production of coal coke as part of the coke-oven gas or in the desulfurization of petroleum in refineries or are contained in natural gas or petroleum gas, by converting the H₂S to sulfur. The specifications to be satisfied by the Claus process result from the operating conditions of modern flexible refineries and natural gas plants and the more and more stringent environmental regulations. The partial combustion of H₂S with O₂ and/or O₂-containing gas to form SO₂ and H₂S serves to adjust a particular H₂S/SO₂ ratio which is required for performing the Claus process. The H₂S and SO₂ contained in the process gas present after the partial combustion of the so-called Claus gas is catalytically reduced to sulfur, for example on Al₂O₃ or TiO₂, both in the combustion chamber and in at least one, preferably two stages. The magnitude of the temperature existing in the combustion chamber is determined by the concentration of the H₂S and the concentration of other combustible components contained in the Claus gas and by the possible use of pure O₂ for the combustion. The partial combustion of H₂S to SO₂ normally is effected at a relatively low pressure of 1.4 to 2.0 bar[a], which in the further course of the Claus process is decreased to almost atmospheric pressure, before the largely desulfurized residual gas is discharged. Therefore, the apparatuses used for performing the Claus process substantially are designed to overcome the pressure loss between the pressure of 1.4 to 2.0 bar[a] existing in the combustion chamber and the atmospheric pressure existing on discharge of the residual gas. The sulfur-containing components, which were not converted to sulfur in the Claus process, are treated further and hydrogenated e.g. by the so-called SCOT process according to the equation

2SO₂+3H₂→H₂S+2H₂O

and then removed by chemical washing. The H₂S obtained then is recirculated into the Claus process (Brochure: “Sulfur Recovery” of Lurgi A G, Frankfurt am Main; No. 1542e/11.02/10).

EP-B-0315225 describes a process for the combustion of a feed gas containing H₂S by using O₂ and air in at least one burner which opens into a combustion chamber, in order to produce a gas mixture containing H₂S and SO₂ for conversion into elementary sulfur by the Claus process. Into the combustion chamber oxygen is introduced through the central tube of the burner, the H₂S-containing feed gas is introduced through at least one second tube coaxially surrounding the central tube, and air is introduced through a coaxial outer tube. Feed gas containing H₂S is supplied to the burner. At the orifice of the burner a flow rate of O₂ of 50 to 250 m/s and of the H₂S-containing feed gas of 10 to 30 m/s is adjusted, and in the core zone of the burner flame a temperature in the range from 2000 to 3000° C. is generated. From the combustion chamber, a gas mixture with a temperature of 900 to 1650° C. is withdrawn. The H₂S and SO₂ contained in the gas mixture is catalytically converted to elementary sulfur, the residual gas is treated by hydrogenation, and H₂S is separated from the gas mixture obtained, which chiefly consists of H₂S, H₂ and CO, and introduced into the burner.

It is the object of the present invention
a) to be able to limit the temperature of the process gas present in the combustion chamber with regard to the maximum admissible application temperature of the material forming the refractory ceramic lining of the combustion chamber,
b) to be able to increase the capacity of existing plants for performing the Claus process without constructional changes and without increasing the temperature of the process gas in the combustion chamber,
c) to be able to optimally perform the partial combustion of H₂S by using O₂ and/or O₂-containing gas to form SO₂ with regard to the H₂S/SO₂ ratio required for the Claus process.

The solution of this object consists in that feed water is sprayed into the process gas present in the combustion chamber. The feed water is processed such that components detrimental to the operation of the combustion chamber are removed; it consists of reused condensate and, if necessary, processed make-up water.

In accordance with the aspect of the invention, the amount of the feed water to be sprayed into the process gas present in the combustion chamber is controlled according to a specified temperature set point desired for the process gas. By suitable measures, such as an auxiliary firing by fuel gas or increasing of the O₂ content during the combustion, it is prevented that the temperature necessary for the reaction falls below a value of 900° C.

By measuring, controlling and regulating the amount of feed water to be sprayed into the combustion chamber for adjusting a desired temperature can be regulated. By spraying in feed water, the amount of process gas is slightly increased, because in essence the advantage of the evaporation heat of the feed water is utilized, with the consequence that only comparatively small amounts of feed water are required for injection. The hydraulic load of the Claus plant and the retention time of the amount of process gas in the combustion chamber therefore are deteriorated only insignificantly.

For the case that in a Claus plant operated with pure O₂ or with air enriched with O₂, the amount of O₂ supplied to the combustion chamber is increased, the additional hydraulic load to be expected can be compensated by spraying in feed water or the total hydraulic load can even be reduced. As a result, the amount of feed gas to be introduced into the combustion chamber and hence the capacity of the Claus plant can be increased or the retention time of the process gas in the combustion chamber can be prolonged. In the latter case, an improved burn-out e.g. with regard to a greater sulfur yield and/or a complete combustion of hardly combustible accompanying components, such as NH₃ and/or CₙHₘ, are achieved without an increase in temperature.

By spraying in feed water, the temperature existing in the combustion chamber and the amount of process gas can be decreased while increasing the amount of O₂ and/or O₂-containing gas supplied to the combustion chamber, without at the same time increasing the amount of feed gas introduced into the combustion chamber. In addition, the Claus plant is hydraulically relieved by spraying in feed water. Due to this effect, a temporary hydraulic bottleneck, as it can occur e.g. in the case of cloggings or encrustations, can easily be eliminated.

For the case that the content of sulfur-containing components in the feed gas is increased e.g. by a higher content of H₂S, the increase in temperature to be expected and the related increase in the hydraulic load is counteracted by injecting feed water. Due to the decrease in temperature of the process gas effected in this way the volume thereof is also reduced, so that the limit of the hydraulic loadability is not exceeded. This measure can also be employed when the amount of feed gas and the O₂ content of the supplied combustion air are increased at the same time, even if the Claus process on the whole is hydraulically relieved by reducing the atmospheric nitrogen.

By increasing the O₂ content of the combustion air, the temperature and the amount of process gas can be decreased while at the same time spraying feed water into the combustion chamber with a constant amount of feed gas. This leads to a longer retention time of the process gas in the combustion chamber, to an improved burn-out and to a hydraulic relief of the Claus plant.

The invention will be explained in detail below by means of embodiments in conjunction with a schematic process flow diagram illustrated in the drawing.

### 1^{st} EMBODIMENT (PRIOR ART)

In a plant for performing the Claus process for obtaining sulfur from feed gas containing H₂S, the following is supplied to the combustion chamber (1) at the same time: via conduit (2) 5000 Nm³/h of so-called Claus gas with a temperature of 45° C. at a pressure of 1.7 bar[a] of the composition
80 vol-% H₂S
5 vol-% H₂O
15 vol-% CO₂,
   via conduit (3) 976 Nm³/h of O₂ with a temperature of 20° C. at a pressure of 1.7 bar[a], and via conduit (4) 4000 Nm³/h of air with a temperature of 40° C. at pressure of 1.7 bar[a]. In the combustion chamber (1) the major part of the H₂S contained in the Claus gas is burnt to form SO₂ according to the equation

2H₂S+3O₂→2SO₂+2H₂O,

so that from the combustion chamber (1) 9977 Nm³/h of process gas of the composition
6.79 vol-% H₂S
4.58 vol-% SO₂
34.24 vol-% H₂O
0.82 vol-% COS
0.18 vol-% CS₂
1.96 vol-% CO
4.56 vol-% CO₂
2.05 vol-% H₂
31.39 vol-% N₂
14.06 vol-% SX (SX=sulfur vapor)
   with a temperature of 1273° C. and a pressure of 1.55 bar[a] flow into the heat exchanger (5) provided directly downstream of the combustion chamber (1). The cooled process gas withdrawn from the heat exchanger (5) via conduit (6) with the composition
7.88 vol-% H₂S
4.58 vol-% SO₂
39.72 vol-% H₂O
0.95 vol-% COS
0.21 vol-% CS₂
2.27 vol-% CO
5.29 vol-% CO₂
2.37 vol-% H₂
6.41 vol-% N₂
0.31 vol-% SX,
   is heated in the heat exchanger (7) arranged in conduit (6) to a temperature of 270° C. at a pressure of 1.45 bar[a] and introduced into the first catalyst stage (8) in an amount of 8601 Nm³/h. The sulfur obtained in the heat exchanger (5) in an amount of 3749 kg/h is discharged from the process via conduit (9). In the catalyst stage (8) the SO₂ contained in the process gas is reduced to sulfur by using further H₂S on an Al₂O₃ catalyst according to the equation

16H₂S+8SO₂→3S₈+16H₃O

and COS as well as CS₂ also are completely converted to H₂S. From the amount of process gas discharged from the catalyst stage (8) via conduit (10) and having a temperature of 353° C. 1246 kg/h of sulfur are separated in the gas cooler (11) mounted in conduit (10) and discharged from the process via conduit (12). The remaining amount of 8341 Nm³/h of process gas having a temperature of 210° C. at a pressure of 1.30 bar[a] flows through conduit (13) into the non-illustrated second catalyst stage, in which SO₂ still present in the process gas is reduced to sulfur by using residual H₂S. In a gas cooler provided downstream of the second catalyst stage, the sulfur formed is separated from the process gas and the remaining process gas is supplied to a further treatment or possibly discharged directly to the atmosphere.

### 2^{nd} EMBODIMENT

In contrast to the 1^{st} embodiment, an O₂ volume increased to 1019 Nm³/h is added via conduit (3) to the Claus gas supplied to the combustion chamber (1) via conduit (2), and at the same time 500 kg/h of feed water are added via conduit (14). By means of this measure, the amount of process gas having a composition of
7.26 vol-% H₂S
4.12 vol-% SO₂
37.66 vol-% H₂O
0.76 vol-% COS
1.39 vol-% CS₂
1.4 vol-% CO
4.8 vol-% CO₂
1.6 vol-% H₂
30 vol-% N₂
12.7 vol-% SX
   and a comparatively low temperature of 1207° C. is increased to 10579 Nm³/h. In the heat exchanger (7) arranged in conduit (6), the cooled amount of process gas emerging from the downstream heat exchanger (5) via conduit (6) is heated to a temperature of 270° C. at a pressure of 1.45 bar[a] and charged to the catalyst stage (8) in an amount of 9267 Nm³/h. The process gas emerging from the catalyst stage (8) via conduit (10) in an amount of 9126 Nm³/h at a temperature of 352° C. is cooled in the gas cooler (11) arranged in conduit (10). Via conduit (12), 1358 kg/h of sulfur are discharged from the gas cooler (11) and the remaining amount of 8984 Nm³/h of process gas is supplied to the second catalyst stage via conduit (13). From the heat exchanger (5) downstream of the combustion chamber (1), 3551 kg/h of sulfur are discharged from the process via conduit (9). By supplying 500 kg/h of feed water into the combustion chamber, the temperature of the process gas on the one hand is increased to 1207° C. and on the other hand the amount of process gas is increased to 10579 Nm³/h; this results in a greater loss of plant pressure. By increasing the amount of O₂ supplied to the combustion chamber to 1019 Nm³/h by simultaneously injecting 500 kg/h of feed water, the temperature of the process gas is decreased to 1207° C. and the amount is increased to 10579 Nm³/h.

### 3^{rd} EMBODIMENT

In a further embodiment of the process of the invention, in contrast to the 1^{st} embodiment, 500 kg/h of feed water are added via conduit (14) to the amount of 5000 Nm³/h of process gas present in the combustion chamber (1), an amount of O₂ increased to 1193 Nm³/h is added via conduit (3), and an amount of air reduced to 3150 Nm³/h is added via conduit (4). Due to this procedure, the temperature in the combustion chamber (1) is decreased comparatively slightly to a value of 1236° C. The amount of process gas discharged from the heat exchanger (5) via conduit (6) remains approximately constant with 9908 Nm³/h. The process gas cooled in the heat exchanger (5) is heated to a temperature of 270° C. in the heat exchanger (7) arranged in conduit (6) and is charged to the catalyst stage (8) in an amount of 8590 Nm³/h. Via conduit (9), sulfur is withdrawn from the heat exchanger (5) in an amount of 3583 kg/h. The process gas having a temperature of 356° C., which is withdrawn from the catalyst stage (8) via conduit (10) in an amount of 8453 Nm³/h, is introduced into the gas cooler (11), from which an amount of 1314 kg/h of sulfur is discharged via conduit (12) and the residual amount of 8314 Nm³/h of process gas is supplied to the second catalyst stage via conduit (13). By increasing the amount of O₂ supplied to the combustion chamber to 1193 Nm³/h and by simultaneously decreasing the amount of air introduced into the combustion chamber to 3150 Nm³/h and spraying 500 kg/h of feed water into the combustion chamber, the amount of process gas is decreased to 9908 Nm³/h and the temperature is decreased to 1236° C.

### 4^{th} EMBODIMENT (PRIOR ART)

The plant for performing the Claus process as described in the 1^{st} embodiment is designed for a capacity increased to a Claus gas amount of 5500 Nm³/h. For this purpose, an amount of O₂ increased to 1297 Nm³/h is supplied via conduit (3) and at the same time an amount of air reduced to 3300 Nm³/h is introduced into the combustion chamber (1). Due to this measure, the amount of process gas obtained rises to 10107 Nm³/h. By adding a relatively larger amount of O₂ and a relatively smaller amount of air, the temperature of the process gas in the combustion chamber (1) is increased to 1309° C. The cooled process gas discharged from the heat exchanger (5) via conduit (6) is heated to 270° C. in the heat exchanger (7) mounted in conduit (6) and introduced into the catalyst stage (8) in an amount of 8586 Nm³/h. The amount of process gas having a temperature of 358° C., which is obtained after the catalyst stage (8), is cooled in the gas cooler (11) arranged in conduit (10) and 1381 kg/h of sulfur is discharged from the gas cooler (11) via conduit (12). Via conduit (13), the residual process gas is introduced into the second catalyst stage in an amount of 8309 Nm³/h and 4162 kg/h of sulfur is discharged from the heat exchanger (5) via conduit (9).

### 5^{th} EMBODIMENT

In accordance with the invention, as compared to the 4^{th} embodiment, an amount of O₂ increased to 1510 Nm³/h is charged to the combustion chamber (1) via conduit (3), via conduit (4) an amount of air reduced to 2480 Nm³/h is added, and via conduit (14) 500 kg/h of feed water are added at the same time. Due to this measure, the temperature of the process gas emerging from the combustion chamber (1) in an amount of 10062 Nm³/h is decreased to 1273° C. The cooled process gas emerging from the heat exchanger (5) is heated to a temperature of 270° C. by the heat exchanger (7) arranged in conduit (6) and introduced into the catalyst stage (8) in an amount of 8586 Nm³/h. Via conduit (9), 3995 kg/h of sulfur are discharged from the heat exchanger (5). From the process gas having a temperature of 361° C., which is discharged from the catalyst stage (8) in an amount of 8454 Nm³/h via conduit (10), 1388 kg/h of sulfur are separated in the gas cooler (11) mounted in conduit (10) and discharged via conduit (12), and the residual process gas is supplied to the second catalyst stage via conduit (13) in an amount of 8307 Nm³/h. By increasing the amount of O₂ supplied to the combustion chamber to 1510 Nm³/h and decreasing the amount of combustion air supplied to the combustion chamber to 2480 Nm³/h and supplying 500 kg/h of feed water, both the temperature and the amount of process gas are decreased.

1. A process for producing sulfur from feed gas containing H₂S comprising burning at least part of the H₂S to SO₂ in the presence of O₂ and/or an O₂-containing gas air at a pressure of 1.4 to 2.0 bar[a], and reducing the SO₂, in the presence of H₂S on at least one catalyst, to elementary sulfur and H₂O wherein feed water is sprayed into the process gas present in the combustion chamber.

2. The process according to claim 1 wherein the amount of feed water to be sprayed into the combustion chamber is regulated according to a temperature set point specified for the process gas.

3. The process according to claim 1 wherein the temperature of the process gas does not fall below the value of 900° C.
